(19) United States
(12) Patent Application Publication
(10) Pub. No.: US 2010/0242074 A1
(43) Pub. Date: Sep. 23, 2010

(54) VIDEO SHARING COMMUNITIES IN A CABLE SYSTEM

(75) Inventors: Alan Rouse, Lawrenceville, GA (US); Charles Dasher, Lawrenceville, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tandberg Television Inc.

(21) Appl. No.: 12/408,831

(22) Filed: Mar. 23, 2009

(51) Int. Cl. H04N 7/173

(52) U.S. Cl. 725/100; 709/204

(57) ABSTRACT

A social networking service defines a community group of cable system viewers as members, who share a common experience or interest based on viewing a common video. Various attributes define how the community group is created and how membership is defined. Members can invoke the service and join an active session thereby allowing them to view and potentially post content that is then displayed in a chat window. A software application downloaded to the set top box creates the chat window on the television screen. Content may comprise text and/or video clips identified by the member. Members can post messages by using their remote control or other device to provide text entry which is processed by the set top box application. Input is received by a social networking server which then distributes the content to the group members.

### FIELD OF THE INVENTION

This invention generally pertains to systems and methods for defining and using a video sharing community in a cable system allowing members to input content which may comprise video clips, that is provided by the system to the community.

### BACKGROUND OF THE INVENTION

Social networking has increased in popularity in recent years. Social networking allows people to interact with others in a remote manner, using various forms of media. Various Internet based web sites are predicated on social networking, and focus on different aspects. For example, one popular website allows user to provide information about them to the world at large. Another website provides a forum for users to indicate what they are doing at the moment. So-called “chat rooms” have been used for years, and can be found focused around a particular experience, hobby, personal interest, work skill, political affiliation, etc.

One aspect of social networking involves members sharing a common experience or interest. Thus, it is possible to readily find a social networking forum centered on a particular interest or life experience. However, most of these social networking methods deliberately attempt to be of interest and accessible to a wide audience. Consequently, many present social network technologies or methods avoid closed communication systems, and instead focus on using widely accessible technologies (e.g., the Internet).

However, cable systems provide a basis of common interest, even though these are to an extent “closed” systems, because users must be subscribers of the cable service provider. The viewers in a cable system often are simultaneously viewing the same video programs and this provides a common, shared experience that can be the basis for social networking. However, up until the present, cable systems had limited interactivity and thus the technology did not facilitate social network in a cable system. Further, providing a social network service to users in a cable system provides an additional level of service by the cable system provider to its subscribers. In an environment where the same video program can be accessed via various technologies, providing an additional level of service ensures that the subscribers of a cable system remain as subscriber of the cable service provider and do not use other technologies for accessing the programs. Thus, the ability to offer a social network service over a cable system provides an additional service opportunity for cable service providers.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates the sources of content and the types of Community Groups to which the content is made available.

FIG. 2 illustrates one embodiment of a Community Group Administrator creating a group.

FIG. 3 illustrates one embodiment of the general system architecture.

FIG. 4 illustrates one embodiment of the set top box.

FIG. 5 illustrates one embodiment of the architecture for the Community Management System.

FIG. 6 illustrates one embodiment of a process of a user interacting with a Community Group

FIGS. 7a-d illustrate embodiments of images on a television displayed to a user in accordance with the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

As should be appreciated, the embodiments may be implemented as methods, apparatus, systems, or computer program products. Accordingly, the embodiments may take the form of an entirely hardware embodiment or an embodiment of a computer executing stored program instructions. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, may be implemented in one embodiment by a computer executing a computer program comprising computer instructions. These computer program instructions may be loaded onto a computer, such as a special purpose computer or other programmable data processing apparatus to produce a specifically-configured machine, such that the instructions which execute on the computer or other programmable data processing apparatus so as to implement the functions specified in the flowchart block or blocks. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions. The rise of social networking is often based on a common interest or experience among the users of a social networking service. This provides the basis for users to interact by sharing their views and opinions with others. In some social network systems, such as Twitter®, various forms of technology are accommodated (e.g., SMS, Internet, instant messaging) in order to provide a wide range of access. Because social network systems intend to reach a broad audience, they tend to avoid focusing on a single technology.

However, focusing on a single technology can be the very basis for social networking. Specifically, one basis for social networking involves a cable system. The subscribers in a cable system share two important aspects: 1) they are subscribers in a cable system, which results in the viewers using similar technology and a common infrastructure, and 2) they potentially receive and view the same programs. Even thought there are different levels of services offered in a cable system (and hence not all subscribers may have access to all programming), it is quite common for subscribers to have access to a common set of programs. Thus, often times, a large subset of the subscribers view the same programs, which may be a “one-time” event (e.g., a live broadcast of a football game) or a recurring serial program (e.g., weekly drama or comedy television program). Many cable system subscribers view a particular program because of a particular personal interest (e.g., a subscriber may purposefully view football games of their alma mater) or because they are a “fan” of the actors in a program (e.g., a popular television series). Thus, cable system subscribers have a common interest or experience based on the television programs they are viewing.

The cable system technology has advanced in recent years to allow more interactivity and two way communication. Although most subscribers are not interested in the cable technology per se, because they are subscribers of a common cable system, there is an inherent common aspect among the group of cable subscribers associated with a particular cable service provider—they use similar technology. This aspect facilitates providing a social networking service to the viewers, because all viewers can be presumed to have a common technology based to interact.

### Overview

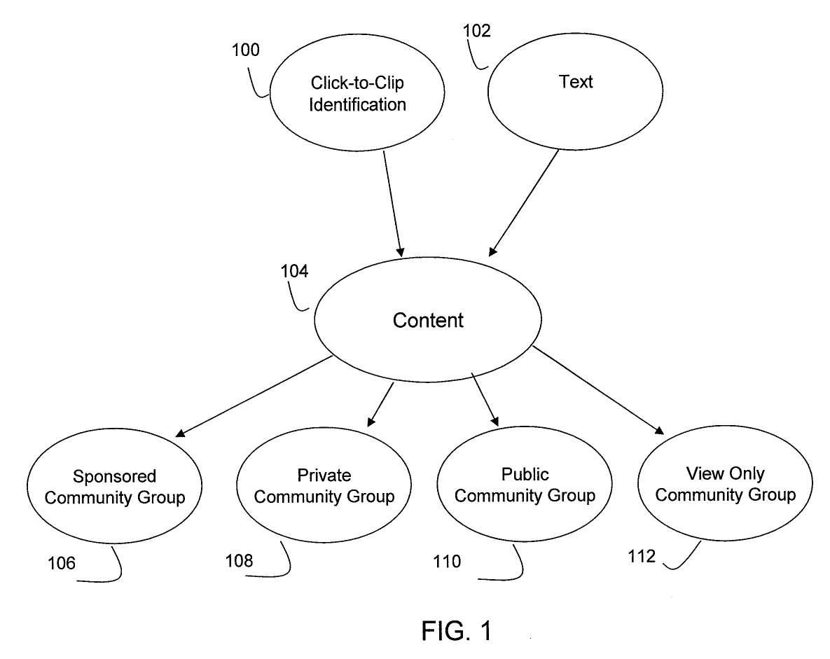

The social networking service disclosed herein involves sharing information pertaining to a common video program. This information is shared with a group within the cable system called a “community.” A number of different simultaneous communities can exist and each is called a Community Group (“CG”). Users of the Community Group are “members” and the information shared among member scan be in various forms, including text and/or video clips. The Community Group is defined before it is used, and can be of various sizes or types and comprises the cable system subscribers that have joined a CG. The information provided by a member is shared with the Community Group. A Community Group that has members currently interacting is said to be “active” or having an “a session.” This is reflected in FIG. 1 where different content types, including video clips 100 and text 102, form the basis of content 104, that is then posted to various community groups, such as the ones illustrated comprising a Sponsored CG 106, a Private CG, 108, a Public CG 110, or a View Only CG 112.

The information shared can include video clips, which the member has “tagged” for purposes of being shared. One such system for tagging video clips is found in U.S. patent application entitled Systems, Methods, and Apparatus for Tagging Segments of Media Content, application Ser. No. 12/347,430 that was filed Dec. 31, 2008, the contents of which are incorporated by reference into this specification. One embodiment of that invention involves subscribers of a cable system that are viewing a video program using a remote control configured to “tag” a video segment in real time. In one embodiment, a special function key on the remote can identify the video clip by antedating the time when the function key is pressed by the user by a fixed time window (e.g., 15 seconds). Thus, if a subscriber views a significant football play during a game that is televised, the user can invoke the “clipping” service by pressing a function key. The system identifies the beginning and end of the video clip. The end of the clip is the time when the button was pressed, and the beginning time can be defined as an earlier point in time (e.g., 15 seconds earlier). The system can then store the beginning and ending times of the video clip for future retrieval. This system is referred to herein as the “clipping system,” “click-to-clip,” or other similar names.

The aforementioned system allows the user to also enter commentary with the video clip, which is associated with the video clip. This allows the user to identify and store various “highlights” of a football game with annotations.

The social network service allows users to utilize the aforementioned tagging capability to identify video clips to share with a particular community. The user can provide the clip with or without commentary to a defined community. Further, in the present invention, members may be restricted to the ability of providing text only (without having to identify a video clip) to the community. If a member provides a video clip, this capability may be restricted to only providing video clips to the CG of the video being viewed in real time. This capability can also be linked to a particular presently distributed video program on the cable system.

A typically application illustrates one embodiment of the social network service. A football game involving a particular college time is scheduled for broadcast at a known time. Some time prior to its broadcast, a CG is created, which typically would involve fans of the college team. The scope of the community can be controlled and defined in different ways, and created by different individuals, as will be seen. At the time of the game, members of the community can view the game as it is broadcasted, as well as sending and receiving “chat” messages (e.g., short text messages). These messages are presented in chronological order in a separate window that is presented to the member on their television set. Further, members may be able to invoke the video clipping service to tag segments of the program they are viewing or other programs previously clipped, and send the video clip along with text to the chat room. For example, a subscriber, who is a devout fan that is watching the football game, could maintain a library of previously identified video clippings of significant plays of their favorite player. When that player then completes a pass during the live broadcast of the game, the viewer could retrieve and post a video clipping of the same player in a previous game, annotating it with their comments.

Community Groups can be of different types, e.g., they can have different characteristics as to how they are created, how membership is gained, and what capabilities are afforded to participants (members). Further, different advertising capabilities can be defined that maximize the advertising effectiveness based on the type of community created. For example, ads targeted to fans of a football team would be targeted to members of the CG activated during the football game.

The system for implementing this service requires new capabilities in the cable headend, and potentially a new ‘chat’ application is downloaded to the set top box. As will be seen, existing mechanisms for distributing this application, streaming video are utilized, and transmitted member input may be variously used.

The system is designed for a cable distribution system that can use a variety of distribution technologies (e.g., coax, fiber, or a combination thereof). Further, the system largely re-uses existing cable system components, such as VOD servers, as will be seen below. It is required that the distribution system be capable of two way communication, and requires use of a set top box, or other equivalent device capable of executing the chat application and processing MPEG video for a television display. The set top box may be a stand-alone device connected to the cable distribution network and a conventional television, which may be either an analog or digital television. In other embodiments, the set top box may be integrated into a television device so that a single physical device functions as the set top box and television, which can occur, for example, when using a CableCARD® type of configuration.

### Content Origination

The content can be classified as being one of three types, although the classification scheme is only to aid in description of the invention. The first type of content is a video clip. The user may identify a video clip by means of the aforementioned U.S. patent application. This capability is broadly referred to as a video clipping service, and allows the user to select a previously identified a portion of a video program. This action may be referred to as “clipping” and the video itself identified can be a “video clip” or “clip.” Although the video clipping service appears to store the video clipping, in the preferred embodiment, it only identifies the video program and the pointers to the beginning and end point of the clip. Thus, although it may be referred to as storing the video clip as a separate video entity, that is what it appears to do and should not be interpreted as to how the services implements that function.

The video clipping service allows a user to store a number of video clips previously recorded, and this is one source for identifying content in the social network service. Another source of video clips is based on the presently viewed program. Both utilize the clipping service and the latter can be viewed as merely reflective of a more current video clipping.

The second type of content that a member may be able to provide to the system is a video clip with annotated text. The aforementioned U.S. patent application allows the user to identify a clip and add text to annotate the video clip. A typical application in the context of the aforementioned football game is a viewer saving clips and including an annotation of the game and/or date. Because the video clip may or may not include annotation, reference to “video clip (only)” or similar refers to a video clip without annotation, and “video clip (w/annotation)” refers to a video clip with annotation, and reference to “video clip” refers to either.

The third type of content a member may be able to provide is text. This comprises alphanumeric characters, and typically is limited to a certain number of characters (e.g., 128 or 256). When text is provided, it is the basis of a message, and hence can be referred to as a message. The act of entering and sending text is referred to as messaging. Messaging is not the same as the annotation of a video clip, because the text is not linked with a previously stored video clip, but is communicated by itself to the community. Further, the act of sending content to the server is often referred to as “posting” and the content is “the post.”

The entry or identification of content usually occurs using the remote control of the set top box. However, other devices may be used. The remote may have a special function key for identifying video clips, and can also be used as a text input device. Although this is not necessarily the fastest or most user friendly mechanism for text entry, the remote control can be used in a variety of ways known to those skilled in the art. In other embodiments, the remote control may be augmented by a text entry device connected to the set top box, such as a keyboard, pointer, touch screen, etc. to facilitate text input. In some embodiments, the set top box may wirelessly communicate with these or other devices, such as a PC, PDA, etc., capable of indicating the functions and/or text input.

Most of the embodiments described herein disclose a set top box as being involved in messaging. Specifically, the remote control or other text entry device interfaces with the set top box to convey text over the cable distribution network to the headend. However, other embodiments may use other technologies and communications facilities to convey the user's text input. For example, a user may generate text using a short messaging service (“SMS”) or other forms of instant messaging, or email communication. Thus, other communication devices such as cell phones, PDAs, netbooks, etc. can be used in conjunction with other communication services and technologies, each of which convey a message and user id to the headend. This input is processed similarly as if the set top box conveyed the text over the cable distribution network.

The user of the service (which is also referred to as the member) may create a video clip independent of the social networking service, and independent of any particular community group. However, the provision of text (e.g., messaging) by itself cannot be created and stored earlier, and can only be created and posted in the context of the social network service for a community group. Thus, the video clipping may be identified previously by a subscriber outside the context of the social network service and then shared (“posted”) by the subscriber in the context of a community group within the social network service. Other embodiments of the social networking service may limit member video clips to only those clips identified within the context of a CG session. However, the messaging capability disclosed herein is generated and provided in real time by a member for posting to a particular community group.

The posting of content is in the context of a particular community group. Further, the community groups must be “active” or have a “session.” There typically are a number of different and concurrent groups with different characteristics or focus. The different groups are typically named to reflect their purpose in some way, and the name can be used to select and/or identify the group for various purposes (as will be seen below). Typically, only a subset of the CG is active at any moment.

At least four different types of CGs classifications are possible. Again, the classification of the groups is to illustrate the invention, and does not limit a particular embodiment to having a certain number or type of community groups. The distinction of the different CG types is usually based on how the groups maybe controlled or created. Other classifications are possible and the definitions are only exemplary.

A “Sponsored Community Group” is a community group that is typically operated by an organization or business. Typically, these groups focus around a particular interest. Typically examples include a college football CG sponsored by the college's alumni organization, a public service group sponsored by a city or a public school or school booster organization, etc. The sponsored CG is typically administered by an entity (or more specifically, an individual associated with that entity), as opposed to an individual representing their own interests. Further, the name of the community group typically reflects the purpose of the organization. The cable service operator may police or otherwise require that the name of the community group be formally associated or authorized with the entity administering the CG. Thus, the “Official Georgia Tech Football” CG may be operated by an alumni organization associated with the Georgia Institute of Technology, or other entity authorized to do so.

As can be expected, the names of certain sponsored CG may involve trademarked names or other names connoting an affiliation with an organization. Consequently, the organization administering the Sponsored CG may be granted certain authorization as to what capabilities it can extend to the members. For example, a sponsored CG may be very popular and by necessity, limit content that viewers may be able to post. In other cases, the sponsored CG may be able to “blacklist” certain members from posting comments. This allows the sponsored CG administrator, for example, to limit messages from viewers which are offensive or otherwise detrimental to the image of the sponsor. In some cases, the sponsor may pay a fee to the cable service operator to administrator a group having the name, and the sponsor could, in turn, charge fees to its members to allow them to participate. As will be seen, advertising in a sponsored group can be very important, because certain sponsored CGs may have widespread appeal and be very popular among a viewer base (e.g., the a specific college football CG). Thus, the impact of targeted advertising may be more valuable, relative to other types of CGs. As it will be seen, the existence of a sponsored CGs may also be advertised, promoted, and thus typically have a wider membership than the other types of groups. Because the community group is based on the cable system's geographical serving area, the community of interest of the viewers is further aligned with the cable system. However, because many cable service providers operate multiple cable systems, the geographical service area of a cable system operator may be very large.

It is possible for the existence of a CG group, or an active session of a particular CG to be promoted by inserting text or an icon into the video program itself. Thus, if a program is associated with an active CG session, a cable service provider may insert an icon into the program or overlay text indicating to viewers that an active session is occurring. Further, instructions can be presented to viewers indicating how to join an active session (e.g., “Press F1 on your remote to join this session”). In other embodiments, an address can be provided on the screen informing viewers where text input can be sent to. For example, an SMS address for texting input can be provided. This allows users on one-way cable systems to interact in a social network chat service by using another infrastructure to provide the upstream communication capability (e.g., from the viewer to the headend).

Another type of CG is a “Private CG.” This is often administrated by an individual member and the scope of the CG is often (but not necessarily) smaller than that of a sponsored CG. For example, a family or set of individuals that are close friends may form a group. Viewers that are fans of a particular television show or that having an interest in a particular area (e.g., home renovating and decorating) may form a group. Because of the size and purpose of the group, the cable system operator may limit or alter the administrative capabilities provided to the Private CG administrator. The membership criteria may be limited—e.g., to invitation only or to a defined list. Further, as evident, the notification or publication of the group may be limited. If membership in the group is limited to a defined set of individuals, then there is no need to advertise its existence. The “Private CG” membership can be defined by the administrator in any way they chose. In contrast, a “Sponsored CG” may be limited as to how membership is determined. Specifically, a Sponsored CG may be restricted from discriminating based on certain criteria (race, religion, etc) but may limit member to other criteria, such as alumni of a school, or members of an organization.

A third type of CG is a “Topical” or “Public” CG. Unlike the Private CG where membership is limited, the topical public group is open, and generally available to anyone who chooses to become a member. The group may be administered by an entity or individual, and may be subject to certain criteria or requirements from the cable system operator. Membership is generally by self-registration. In this type of membership, any subscriber of the cable system can request to join.

Finally, a fourth type of CG is a “View Only” CG. This CG typically is open to membership to any member requesting to join. However, the member is usually not allowed to post any messages or video clips to the group. This type of CG can be compared to a “blog” where the content is controlled and generated by the administrator. Hence, only posts by the administrator are allowed. A View Only CG may be used when the administrator posting the messages has a certain “name recognition” or expertise in the area. For example, a well known sports commentator could create a CG where only his comments are posted to the CG. Thus, this View Only CG can be used by a sports commentator to provide real-time commentary associated with the play-by-play televised program. Allowing other members to post data would “clutter” up the opinions of the commentator. Alternatively, member to this CG can be based on a fee paid to the administrator, or by the administrator agreeing to receive targeted advertising during a CG session. In such cases, the existence of the CG and its schedules session may be greatly publicized and open to any member.

Each of the CG types is above is identified by a name. The name is only illustrative, and different names could be used. Further, each particular CG must be identified by a unique name (e.g., “Official Georgia Tech Football” CG). Thus, each CG group name should be unique, and typically is reflective of the purpose and common interest of its members. (Obviously, CG may be created and advertised in order to create interest in the cable system subscriber in order to attract members.) As evident, the different types of CG are essentially groups having different administrative options, different restrictions, have different advertising potential, etc. Thus, any number of types of groups could be created, and this merely reflects a convenience for the cable system operator to categorize different aspects. For example, a View Only CG and a Sponsored CG may be promoted to the cable population at large. It would be logical based on the prior examples for such groups to have a membership policy that allows any subscriber to join. Similarly, based on the prior example, a Private CG may be not publicized, and may be limited to invitation only. Thus, to facilitate implementation, the cable system operator may define profiles of the different attributes of the CG which allows for convenient establishment of the group as opposed to requiring the cable system operator to creating a unique set of attributes each time a CG is created. It is expected that applications for the different types of groups will be created that are not fully anticipated. Thus, it is quite possible that applications will develop for a View Only CG that is not wide publicized, nor allows unlimited membership. Thus, one benefit of the present invention is the flexibility afforded for different applications of the social networking service.

### Community Group Attributes

The cable system provider, as the social networking service provider, may create a set of CG attributes and classify each as a unique type. Four different types were identified above, but other types can be created, or these can be created with different attributes. The definition of the attributes for a CG type is accomplished by the cable system provider, not the administrator of the CG. The CG administrator requests creation of a type of group from the social networking service provider (the cable system provider), and the cable system provider (may) grant the request. The request may be done automatically, or manually, but the ultimate determination of how a CG operates is determined by the cable system operator.

The attributes defined by a cable system operator can vary, and the following is an exemplary list of attributes that can be defined and associated with a CG profile.

Membership Type: this defines how subscribers are initially allowed into the CG (e.g., how subscribers can become members). The CG may be limited to a certain type of membership, or the CG administrator may be allowed to select which types are allowed in the CG when initially established. Some membership types include:
a. Authorized List—the CG administrator must identify each user authorized to join the group. Typically, this is for a small CG, such as a Private CG. The user can be identified at login using a user-id or other type of identifier. This can become unwieldy if the membership is very large.
b. By Invitation—the CG administrator can send a request to a particular user asking them if they would like to join a particular group. The request can be sent to the cable system community at large, in response to a particular user searching and selecting a particular CG, or on some other basis. Requests to join can also be sent using other media (e.g., direct mail, email, etc.).
c. By Self Registration—a viewer of the cable system could initiate a request to joint a group, where the request is typically automatically allowed.
   As evident, certain Membership Types are more suitable for certain CG types. A CG that is intended to have a wide focus would not likely utilize an Authorized List form of membership establishment because updating it can be time consuming. Alternatively, a Sponsored CG may be limited to those viewers that have paid a membership to an organization, and only on that basis are allowed to become a member of a CG. Self registration, on the other hand, does not require manual processing, and can be done in real time over the cable system.

Advertising: this defines whether advertising will be provided to the members of the CG. Defining a CG having a common interest, such as college football fans, provides a valuable opportunity to provide targeted advertising during certain events, namely, during football games. The advertising could be provided during a particular CG session, or at any time. In some embodiments, CGs having a wider appeal will have targeted advertising provided to members whereas other CGs (e.g., Private CGs) may not.

Content Controls: this defines what type of controls the CG administrator may define for members with respect to providing content. The Content Control indicates whether a member can post a video clip, limitations on the video clip (e.g., duration, whether it was generated from a present video program, or previously recorded, with or without annotation), and limitations on text messages (allowed or not, number of characters, etc.) Content controls can be defined for all members, or a subset of members. Thus, a View Only CG may define two commentators that can post comments during a football game, but where all other members are prohibited from providing content.

Publication of the CG Name: this defines aspects related to publication of the CG name. Typically, this is performed to 1) increase membership, or 2) inform members of an upcoming event. This attribute encompasses how and when the CG name will be informed to the membership at large. For example, a list of current CG names may be provided to a viewer when requested. This could be provided as a schedule of active or scheduled CG sessions overlaid with a program guide, or other indicated by an icon on the program guide. Or the viewer may search a list of CGs that is affiliated with a particular topic. As evident, certain CGs may be restricted from publication. It would not make sense, for example, to publicize a Private CG groups wherein membership is only via by Authorized List. Further, a Private CG administrator may not even desire the group's existence to be publicized at large, since membership is limited to members that are known by the administrator (for example, family members).

Black List Creation: this defines whether a CG administrator can create a “black list” of members which are precluded from providing content, or excludes a membership of a viewer. This addresses the situation where one or more members of a CG are ‘disrupting’ the functioning of the CG by posting offensive content, either in the form of video clips, annotation to the video clips, or text messages. The CG administrator can add the source (identified by user-id, which is typically linked to set top box identifier) to a blacklist which excludes the member from participation in the CG. This could prevent the member from being recognized prior to joining a live event, or prevent them from receiving notifications of an event or posting any content.

Other CG attributes may be defined, and the above list is only exemplary as to the type of attributes that may be linked to a CG.

### Community Group Administration

The CG administration refers to the actions done by the CG administrator. The CG administrator performs various functions associated with creating, maintaining, and managing membership in the CG. In many instances, the administrator comprises one or more members authorized to make changes, and is often the user (as identified by user-id) that created the CG. Typically, the cable service provider authorizes the CG to perform certain functions in the group, and these may be indicated either by interacting over the cable system or accessing the community group management system (“CMS”) via a computer through the Internet. For certain groups, such as the Private CG, which is targeted at small groups, the administrator is typically the individual creating the group, and does so using the set top box communicating through the cable system. In other embodiments, certain CGs (such as having particularly memberships), a more sophisticated user interface may be provided to the CG administrator through the Internet. The present embodiment will be discussed in the context of the administrator using the set top box to administer the group, but the present invention is not limited to a particular technology used to administrator the CG.

The CG administrator typically performs a series of selections when the CG group is initially established. These are typically provided to the administrator via a series of “pages” displayed on the television, where the administrator can input information using a remote or other suitable device to provide information such as the name of the CG, type, and select a particular attribute option. The possible attributes that the CG administrator may select is typically determined by the CG type. Further, the CG administrator may require that for certain group types the CG group administrator “manually” register (e.g., provide information through another channel, than using the set top box). For example, if the CG administrator desiring to establish a Sponsored CG where advertising is involved (and hence a portion of the advertising revenue is shared with the CG administrator), may require a contract to be executed between the CG administrator and the cable system provider before that type of CG can be established. In other instances, the use of a particular name for a Sponsored CG (implying affiliation with a certain group or trademark holder) may require that due diligence investigation is performed by the cable service provider before that CG name is registered in the system. Because names are unique, once assigned, that name cannot be used by another CG administrator. This would avoid unauthorized individuals establishing a Sponsored CG with names such as “Official NFL Fan Group” when they are not authorized to do so. Of course, should it later be discovered that the name of a CG is an unauthorized name or implies an unauthorized link with a trademark holder; the cable system provider can always disable or terminate that group. However, controls may be provided by the cable system via the CMS to avoid such situations. Thus, creating a group online via the CMS may be limited to certain types of groups.

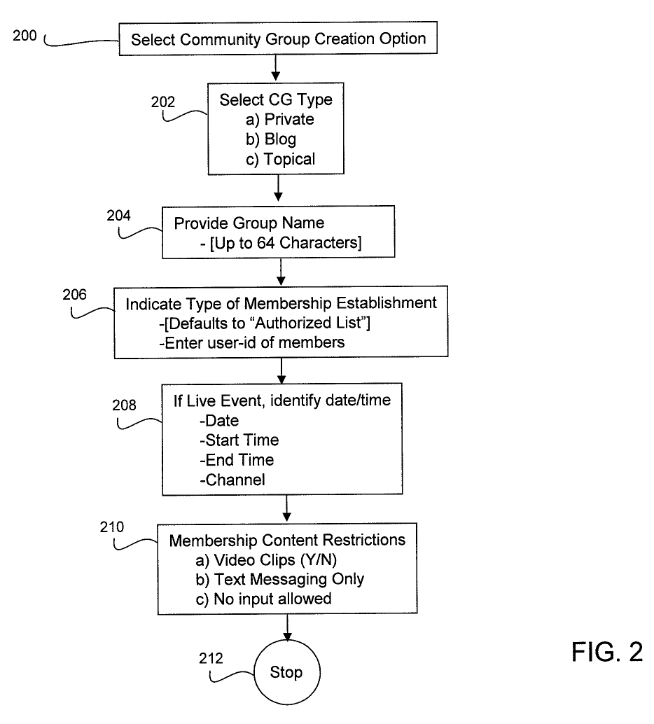

FIG. 2 illustrates one embodiment of a user creating a Private CG group. This presupposes that the subscriber has requested and obtained a user-id and a password. The user selects a function key, or otherwise selects a menu option (not shown) that indicates the subscriber wishes to establish a CG in step 200. The actual set of questions and options presented to the subscriber can vary, and this illustrates one possible set of options. The next step is for the system to ask the subscriber to indicate what type of CG is requested. In this embodiment, the subscriber can only indicate on-line (e.g., using the set top box) to establish a Private, View Only, or Topical CG. This is because the Sponsored CG may be so complex that the cable system provider requires the use of another interface, or execute other agreements in person with the cable systems operator. This embodiment merely illustrates that not all types of CG groups may be allowed to be created on-line and does not prevent all types for being so created.

Assuming that the user has selected to create a “Private” CG in step 202, the next option is for the subscriber to indicate a name of the group in step 204. The subscriber could indicate “Joe's Bulldog Football World” reflecting the subscriber's interest in the University of Georgia's football team (whose mascot is a bulldog). In a private CG, the system may “police” the name of the group to preclude offensive names, but because such CGs may not be advertised or may not be searchable, or are limited to a defined membership, the name may not be policed in some embodiments. In other embodiments, particularly when a CG is formed that is open to public membership, the name of the group may be checked and offensive terms may be precluded from entry. In various embodiments, the name of the group may be limited in size (e.g., 64 or 128 characters).

In step 206, the type of membership may default based on the type of group created. In this embodiment, a Private CG requires that a list of authorized users (indicated by user-ids and possibly with associated passwords) are stored in the CMS. Thus, in this embodiment, a Private CG can be easily created by a user, and it assumes that the CG administrator controls membership. Typically, the administrator has been informed by the other members-to-be what their user-ids are. The administrator then enters the user-ids individually into the CMS. Passwords may selected by the user, or given to the user by the administrator.

In step 208, the CG administrator can indicate a particular video program to link the CG with. This effectively limits the CG group to a defined program, or set of programs. This may be referred to as a “Live Event,” especially when it is scheduled with a broadcast video program. Continuing with the example, the subscriber (Joe) would identify to the system the upcoming date, time and channel number associated with the upcoming football game involving the University of Georgia. Thus, during the broadcast of this game, a CG session would become active, and the system would members to join the session, and interact by viewing and sending messages (or other content). The same CG can be “reactivated” for the next game to create another session, and can be indicated as a separate menu option after the CG has been created (e.g., a recurring event, or scheduled for multiple advance instances). The menus for accessing an existing CG or a scheduled Live Event are not shown. An “active CG” generally refers to a CG that has or may have a session, whereas a “session” refers to that particular social networking internetworking instance involving that CG.

In step 210, the CG administrator can specify what types of content restrictions are imposed on the members. In this embodiment, a Private CG administrator can select from a number of options. In other embodiments, the membership content restriction may default based on the CG Type indicated. For example, a “View Only” CG may be defined as prohibiting all members to post content.

This flowchart represents only one possible embodiment, and further, one possible embodiment for a Private CG type. Variations on the attributes, defaults, and other options selectable by the CG administrator are possible.

### Community Group Management

Community Group Management refers to the actions taken by the social networking provider (“Provider”) (e.g., the cable system operator) in conjunction with managing various community groups. Certain CGs require less management by the Provider, such as the Private CGs. Other types of CGs require more active management by the Provider, such as Sponsored or View Only CGs. However, the degree of management depends on various factors, and may depend on the commercial opportunities and applications that can arise from using the present invention. For example, a View Only CG may be small and not require much management by the cable system provider. However, if the View Only CG grows to a large membership, and the subject matter is of interest to advertisers, then the Provider may desire to sell advertising in conjunction with that CG at certain times. This requires the Provider to establish what advertising will be provided to the CG and when. Further, for some events (e.g., championship football games), the Provider may desire to publicize the CG group to a greater degree.

Thus, the Provider may establish various attributes on a CG session basis. Other attributes can be established for tracking which members become activated during a particular Live Event associated with a CG, which ads are selected by viewers, how many messages are posted, etc. Thus, the cable system provider may analyze this data for marketing purposes. In summary, CG management involves parameters, attributes, and settings determined by the cable system provider, not the CG administrator. There is typically no signaling from a member's set top box or a CG administrator involved in CG group management. Rather, the social network service provider's personnel interact using a “back-end” system access. Thus, the set top box is not typically used by the Provider to establish these attributes.

### Architecture

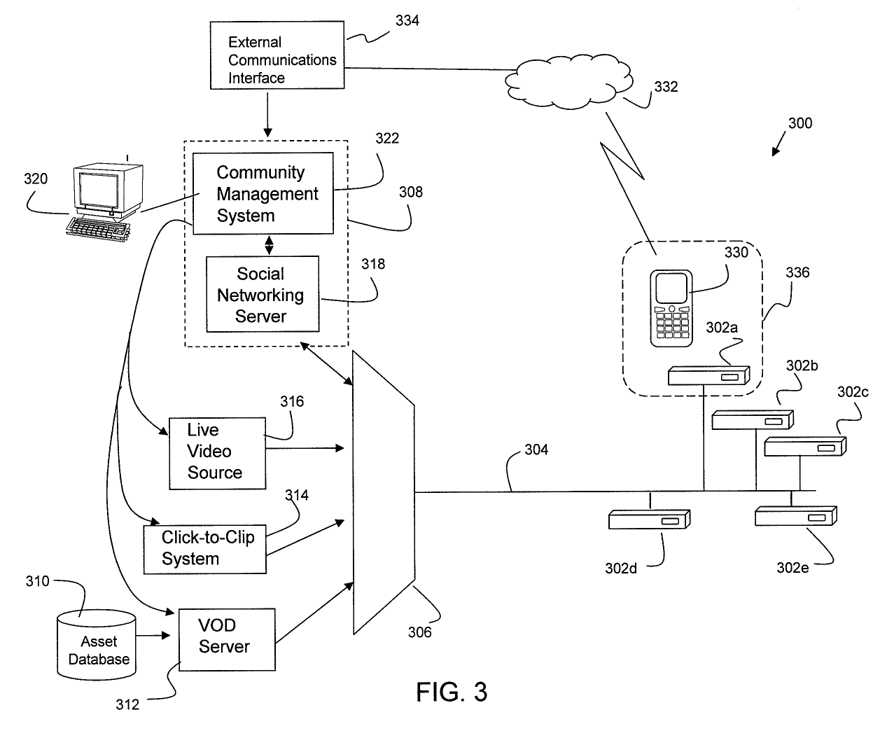

The overall system of one embodiment of the present invention is shown in FIG. 3. In FIG. 3, the social network system 300 comprises a plurality of set top boxes 302a-302e associated with a cable distribution network 304. The set top boxes in FIG. 3 are, in certain contexts, used to refer to a subscriber indirectly, because in many cases the subscriber will have only one set top box. If the subscriber has two or more in their household, each set top box is usually still associated with only one subscriber.

The subscribers, which are as referenced by the set top boxes 302, can be members of one or more CGs, or may not be a member of any CG. For purposes of illustration, it can be assumed that set top boxes 302a-c correspond to members of one CG, and set top boxes 302d-e are member of another CG. The set top boxes comprise a software application which enables certain aspects of the service. As will be discussed in additional detail, the set top boxes have a “chat” application downloaded to the set top box which is required to be present prior to the subscriber using the service. The “chat” application processes can be described as providing two main functions. First, the chat application processes subscriber's input and sends it to the social network systems 308. The input can be information of a text message and/or a video clip. The application also provides additional display capabilities for displaying chat messages or video clips in a pop-up window displayed in conjunction with video program, as well has handling notifications and other functions.

The cable distribution plant 304 may be a coax, fiber, hybrid, or other technology. It typically has a two-way capability in order to convey messages from the set top box to the headend. Many prior art cable systems already incorporate the ability for two way communication, and changes to the cable distribution plant are typically not required to implement the service. For cable systems having a one-way communication system, it is possible to implement the service by requiring viewers to use another communication system for conveying information/requests to the headend. For example, viewers could use a SMS service associated with mobile phone service to provide input to the server. Thus, SMS messaging could be used to establish, join, and provide text input from viewers. Additional modifications may be required to adapt the various capabilities described herein if a one-way cable distribution system is used, but these modifications are within the ability of one skilled in the art who has been informed of the invention. This is illustrated in FIG. 3 by a viewer (indicated by a dotted line 336) associated with set top box 302a also having in their possession a cell phone 330 capable of texting (e.g., via SMS, email, etc.). This service is provided by a wireless carrier 332, which conveys the messages to an external communications interface 334 of the social network system 308. In turn, the external communications interface 334 provides the text message to the CMS system 332. This is one manner in which the service can be provided on a cable system having a “one-way” cable plant, which allows a “back door” method of sending messages from a viewer. The reminder of this disclosure presumes that a two-way cable network is being used.

Messages sent from the set top box (or message sent to the set top box) are conveyed by a multiplexor 306, which is part of the cable headend. The term “cable headend” in one context (specifically, from the perspective of the set top box) is all the equipment residing in the cable system at the head of the cable distribution system. However, another more granular context is that the cable headend is the equipment in the cable system that is required to provide existing video distribution services, and does not encompass the social network system 308 which is located in headend. The context should be clear when the term “cable headend” is used.

Several systems providing video programming may be involved, as shown in FIG. 3. Because the social network service presumes that viewers are sharing a common viewing experience, there is a “common video” that is being viewed by the viewers. The common video is the video program that is the focus of the CG session. Various sources of the common video program are possible and FIG. 3 illustrates only a few, and others may be incorporated. First, a VOD server 312 and associated database 310 may be the source of the common video. If the VOD server is used, then a mechanism for ensuring a common start time for the members is required or a mechanism is defined for allowing members joining the CG session to join into the VOD stream. In other words, sharing a common viewing experience requires viewing the same program at the same time and this program is the “common video.”

A frequency used source for the common video is the live video source 316, which can represent broadcast network television, premium programming, local programming, etc. In other words, the program is readily available to subscribers in real time. At this level, it is not critical as to whether the source is local or national, or whether it is distributed by satellite or not. Access to the common video program may require a certain level of service subscription by the members, however. Thus, returning to our example, a college football game may be broadcast on a network channel or local channel for distribution. Because of the nature of the live video source and its distribution on the cable plant, all viewers accessing the video program see it at the same time (e.g., in progress); hence it is a common video program.

In the above example, the football game program can be viewed by non-members of the CG as well as members of any CG, independent of whether or not there is an active CG session. An “active CG session” refers to a CG where members are interacting and requires there is a video program which is the basis of the common viewing experience (“common video”). An “active member” refers to a subscriber that is a member of a CG and which has also joined a CG session. Thus, a member can view the video without joining a CG session (and not be considered an “active member”), but if the member does join a session, they are considered an “active member.” Although not necessary, an active member will often actively participate in the CG session by sending content, but there is no requirement to do so after joining a session. Thus, active members can merely passively watch the chat activities after joining a session. Typically, there are at least some members of a CG that are active during the common video, and it is assumed that are some active members interacting with the social networking service when a scheduled Live Event occurs (e.g. a scheduled CG session occurs).

The social network system 308 comprises two main components. First, a social network server (“SNS”) 318 handles the interactive aspect with the members during an active session. Specifically, the SNS receives content from the various set top boxes 302, which can be in the form of text messages and/or video clips. The SNS chronologically arranges the content and then distributes them back to the members of the group. The SNS can provide this chat information to the members in different ways. In one embodiment, the content comprises data (alphanumeric) that is carouseled back to the set top boxes. Thus, the SNS server is shown as being able to provide content to the headend equipment 306 and back over the cable distribution plant 304 to the set top boxes 302. The content carouseled comprises the text previously provided by active members and as well as potential data identifying the video clips if (not the video itself). The chat information, when carouseled, is sent serially (and in order of receipt) to the members. Thus, the most recent received text message at the server is the latest chat information carouseled to the set top box(es). Various embodiments of the server may queue messages and repeat their transmission in the carousel. In another embodiment, the SNS can process the content into MPEG video data that is generated in real time and placed on a separate channel. The members then tune to that channel as the way for retrieving the chat information. In another embodiment, the SNS sends the chat information to the members using an IP connection. Other embodiments are possible. In any embodiment, the chat room data is managed in the real time by the SNS by receiving the inputs from the set top boxes and sending the processed inputs as chat information back to the members of the group.

The chat information (or “chat data”) is presented to the viewer using a “chat” application resident in the set top box. This application receives the chat data and generates a window separate from the common video program for presentation to the viewer. In one embodiment, the window can be overlaid on top of the common video. Doing so, however, precludes viewing the entire image of the common video, and hence, in another embodiment, the set top box shrinks the common video image into a small window, and generates the chat room window along side in a separate window.

The community management system (“CMS”) 322 is the portion of the social network system 308 that performs various support functions necessary to conduct active CG sessions, including CG administration and CG management. For example, the CMS is typically responsible for creating a CG group, maintaining information as to its name, maintain a corresponding list of members, maintaining user-ids, coordinating operation with other system elements, etc. Viewers typically interact with the CMS at different times and for different reasons. First, viewers must first obtain a user-identifier (“user-id”) prior to joining a CG. Thus, the CMS provides the process allowing a viewer to obtain a user-id, with the necessary validation and authorization procedures. The CMS may check that the viewer is using a legitimate set top box (e.g., not a cloned or blacklisted unit), has paid their bills (e.g., in good financial standing with the cable service provider), or has the appropriate service level (if imposed by the cable service provider). The CMS ensures that unique user-ids are selected and allocated. The CMS may be also able to remove a viewer if they request so of if the administrator commands such.

The second time that a viewer may interact with the CMS system is if the viewer desires to create a CG group. The user creating the group, and which has the rights to manage the CG, is called the CG administrator or coordinator. The CMS system provides the various options and determines which parameters are compatible with the CG group type selected, as previously described above. Thus, the CMS ensures the CG group names requested and assigned are unique, enforces the membership terms, schedules when a Live Event occurs, etc. Thus, the support data created and processed in order to create a CG is handled by the CMS. The CMS may allow the creator of the CG group to modify its characteristics. For example, in a Private CG group, the administrator maintains a member list. Obviously, members may wish to join in, or drop out, and that function is performed by the administrator interacting with the CMS. Thus, the administrator may interact with the CMS during the creation of the CG, and then later when the CG is in existence to alter or modify various settings. The administrator can also use the CMS to terminate a CG.

Another instance where a viewer may interact with the CMS is when there is a request to identify or join an active CG session. The CMS knows which CG exist, which are active, their type, etc. Consequently, a viewer may request to search for the existence of a certain CG group, ascertain when a next Live Event is to occur for that CG group, how to become a member of a CG (if allowed), etc. Thus, even publication and possibly even advertising of the CG group may be handled by the CMS system. A viewer who is a member will also typically receive notifications of the beginning of a CG session from the CMS, if that capability is provided. Notification of an upcoming session is different than notification of content being posted in an existing, active CG session. The former is typically performed by the CMS, since it knows which groups exits, when they are scheduled, and who the members are. The latter (notification of content being posted in an active session) is typically performed by the SNS. The SNS handles the interaction sessions, and typically does not send out messages regarding upcoming CG sessions.

The CMS is also accessed by the cable system provider. Recall that the cable system provider determines (via CG management) the profiles of the various types of CG groups that can be created. Further, certain types of CG groups may be limited as to how they are created. That is, the cable service provider may require manual creation of certain type of groups, and preclude subscribers from creating certain type of CGs from their set top boxes. Further, the cable service provider also has the capability to create blacklists of users, either based on the user-id assigned to a viewer, or based on the set top box identifier (and thus precluding a viewer to avoid this mechanism by simply obtaining a new user-id). Thus, for a number of reasons, the cable service provider has direct access to the CMS. This is represented by terminal 320 connected to the CMS. In various embodiments, the terminal 320 can be a computer accessing the CMS over a private network or the Internet. This embodiment is also intended to be represented by the terminal 320.

The CMS system also performs other functions. In addition to collecting and maintaining information necessary to conduct an active CG session, the CMS also manages active CG sessions. The CMS communicates with the various other components necessary to conduct a CG session, and coordinates their actions.

First, the CMS manages the SNS 318. The CMS informs the SNS about information for an upcoming CG session so that the SNS can process and distribute the content pertaining to a particular CG session. The CMS ensures the SNS is running and available, that sufficient resources are available, etc. In FIG. 3, the CMS is shown as receiving messages from the SNS. Thus, in one embodiment, all messages from members are directed to the SNS, and it decides whether to forward certain administration messages to the CMS. In other embodiments, the CMS may receive certain types of administrative messages directly. However, real time session content (“chat information”) is passed to/from the SNS and the set top box without involving the CMS. The CMS and the SNS are shown as different components in the social network system 308, but can be implemented in various embodiments using one or more processing systems.

The CMS also interacts with other components in the cable headend. Returning to the football game example, if a CG session (such as a “Live Event”) is schedule around a college football game broadcast, the CMS needs to confirm that the broadcast is actually occurring. The broadcast can be postponed, rescheduled, blacked-out, pre-empted, etc. Thus, the CMS interacts with the live video source 316 to ascertain the common video program is available (which in this high level depiction, also include systems that maintain programming information about the live video program).

The CMS also interacts with the video clipping (“click-to-clip”) system 314, which is the system that identifies (tags) video clips, described in the aforementioned patent application. If the CG group allows members to post video content or a member indicates a request to review a video clip, that content is stored and/or obtained using the click-to-clip system. The representation of the click-to-clip system is a high level representation. It typically involves components such as a database for storing the video clip identification information (such as program identifier, beginning tag identifier, and ending tag identifier), and a database storing the programs, etc. The social network system 308 typically does not store or retrieve the video clips, but relies on the click-to-clip system as described in the aforementioned patent application to do this. Further details as to the architecture of the system are also found therein.

The CMS may also interact with the VOD system comprising the VOD server 312 and asset database 310. It is possible that the common video may originate from the VDO server, and further, the VOD system may be also involved in providing the click-to-clip capability. Thus, the CMS may access the VOD server for a variety of reasons during management of an active CG session.

Each of the Live Video Source 316, click-to-clip system 314, and VOD server 312 is connected to provide a video stream out to the cable distribution plant 304 by way of the multiplexor and other equipment in the headend 306. Each of these typically video sources provides video independent of the social network service in some manner. Obviously, the live video source and VOD service are well known in the art, and the clip-to-clip service can be implemented independently of providing a social networking service. However, each of these also may interact in some manner by the CMS system when providing social network service, as will become evident.

### Set Top Box

The set top box is adapted to provide the social networking service. This requires a “chat” application downloaded to the set top box. Existing mechanisms for downloading an application are known in the art, and can be used to upgrade the set top box. The chat application is used primarily to send and receive chat data.

To send data, the user invokes the chat application. Subscription may or may not be required by the service provider. Further, whether there is any charge levied to the subscriber is determined by the service provider. Typically, invoking the service occurs via the user pressing a function key on the remote, or otherwise indicating that the social network service is desired. In some embodiments, a member of a group may be notified of an upcoming Live Event for a CG of which they are a member of. This message can be presented to the user in various ways, including overlaying a text image on the television screen informing the user, where the user then invokes the function key on the remote. Other embodiments may communicate such information via a newsletter, email, etc. Alternatively, the viewer may invoke the function key without being notified or reminded. After invoking the function, the set top box will prompt the user for a user-id and password. This capability allows the service flexibility to allow a viewer to be a member of multiple CGs, as well as multiple individuals in a household using a single set top box to each be a member of a separate CG. A password is typically used to ensure that membership of a viewer cannot be impersonated by another viewer. Further, this capability can be used to provide the social network service in a set-top-box independent manner. Specifically, a member could invoke the service on various set top boxes in their house, or while viewing a program in someone else's house.

In any case, the set top box processes the function request and sends a message to the cable headend, specifically to the CMS 322. The message typically includes certain identifying information, such as the viewer's user-id (presuming it has been previously established) and password. The CMS verifies that the user is a member of the CG and the password is correct. Multiple attempts may be allowed if there is an initial mismatch. Assuming that an active CG is in session and the viewer is validated, the CMS informs the set top how to access the chat room if tuning to another channel is required. Thereafter, the SNS provides the chat information in some broadcast manner. The chat room information can be conveyed in different forms. In one embodiment, the SNS generates an MPEG video stream with a separate PID value, where the video stream conveys the chat messages in real time. In this embodiment, the CMS would inform the set top box which channel to select, and the set top box would create a “picture-in-picture” by displaying both the presently selected video as well as the chat video. This embodiment requires the set top box to incorporate dual tuners, e.g., the ability to process two separate MPEG data streams. Typically, the SNS provides a limited history of chat messages from members, which is updated as new content received.

In another embodiment, the chat room information is data. The data is the chat room messages and links to any user-identified video clips. This data is carouseled by the SNS continuously over the cable distribution plant 304 which is transmitted so that a number of set top boxes can receive the information. The set top box chat application picks up the data from the carousel, and displays it in a second window generated by the set top box. In this embodiment, a dual tuner may not be required in the set top box. However, because there may be multiple chat information streams carouseled simultaneously, a chat information identifier may be previously provided to the set top box allowing it to select the appropriate chat information. In any embodiment, the set top box may limit the number of postings (messages) presented to the viewer, because of display space limitations. It is possible that the set top box may retain, e.g., the last 25 postings, but only display the most recent five postings.

When a user is participating in an active CG session, the member may desire to generate content to post. The user may type in text and/or provide a video clip. The set top box application can accommodate the user's input in various ways. In one embodiment, the set top box communicates with a computer (e.g., laptop, PDA, netbook, etc.) or other text entry device in some manner to receive text. If the user desires to identify video clips, the user can also identify video clips as described in the aforementioned patent application. The video clips could be those presently created by the viewer involving the common video program, or video clips previously created by the viewer and stored in the click-to-clip system. The chat application receives the input and transmits it to the SNS for processing. Typically, an active CG session is identified by a numerical value, so that set top box includes the CG session identifier in each message and the SNS uses that value to correlate the input message to the appropriate CG session. It is expected that multiple CG sessions can occur in the SNS at any given time.

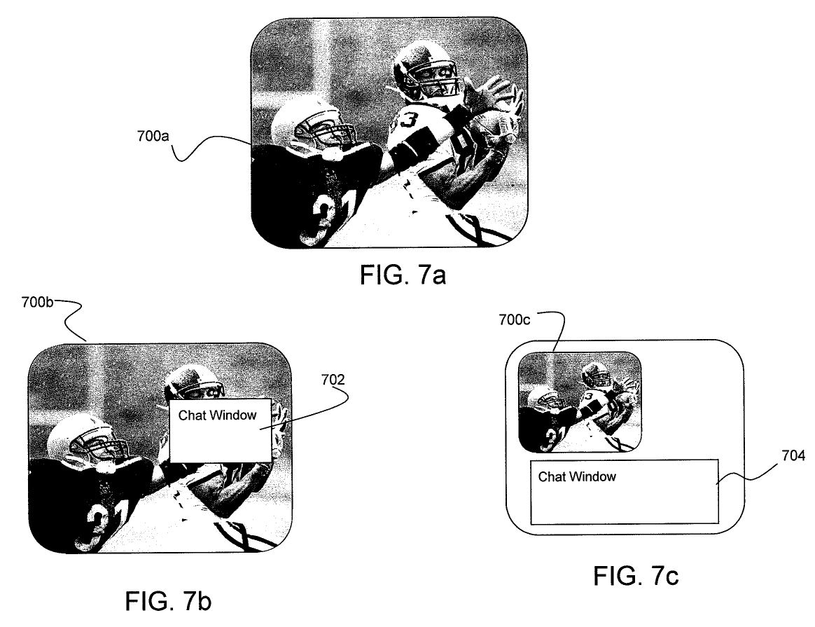

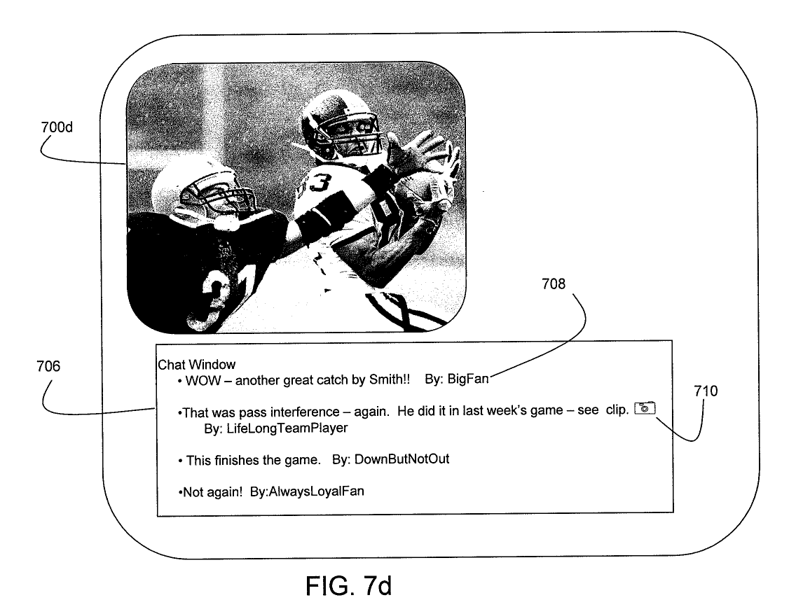

Once the user is viewing a chat window (or pop up window), a series of messages are displayed in chronological order (see, e.g., FIG. 7d). The chat window is able to only display a fixed amount of information, and the messages automatically ‘scroll down’ as new messages are added by members. A user joining a CG session may desire to know the previous messages (e.g., the ‘thread’) to better understand the context of messages. The user may be provided with a scroll function using the remote control, which the set top box chat application processes and alters the messages shown in the chat window. Further, the user may use the remote control functions to select a particular posting to view a video clip (if the post includes a video clip). Again, the set top box chat application interprets the function key, and would initiate a request to the SNS to play a video clip.

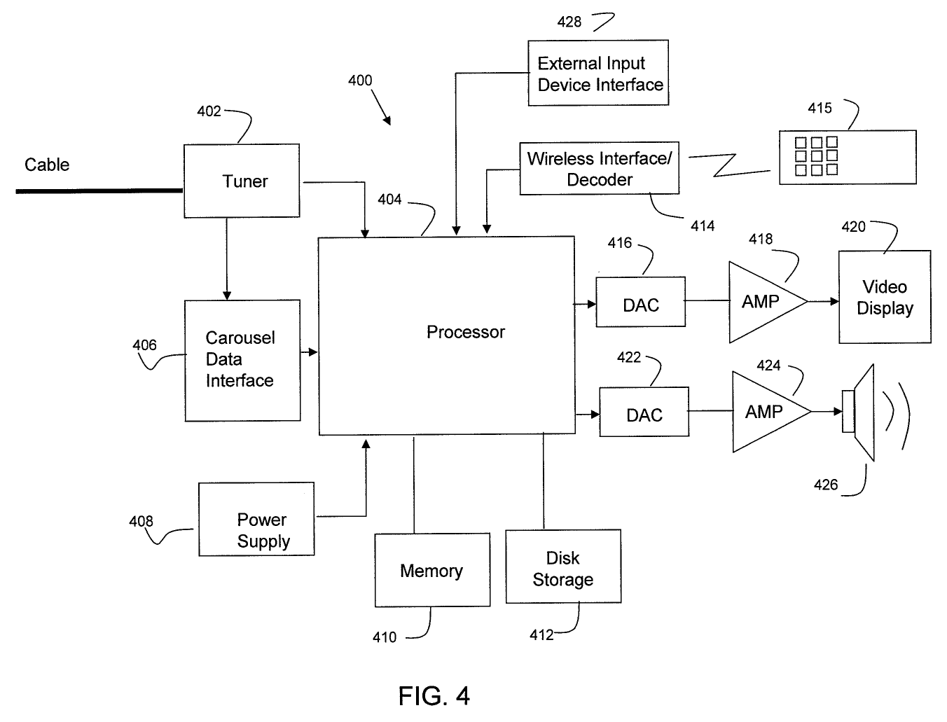

One architecture for the set top box is shown in FIG. 4. In the embodiment illustrated in FIG. 4, the set top box 400 comprises a tuner 402 which receives the signal from the cable. The tuner includes the various components to both provide a digital video signal to the processor 404 as well as identify data from carouseled on the cable. In some embodiments, the tuner 402 represents a dual tuner, able to receive the common video and the chat information, both of which are conveyed as MPEG digital streaming data. If a carousel is used, the carouseled data is provided to a data interface 406 which provides the data to the processor 404. The processor receives power from a power supply 408, and also receives as input data from a wireless interface/decoder 414, which receives input from the remote controller 415. The processor also provides the appropriate signals to a digital-to-analog converter 416 and 422 which is amplified by amplifiers 418, 424, to provide signals to a video display 420 and audio signals to a speaker 426. Processor also accesses memory 410 which comprises both RAM and ROM (or similar semi-permanent memory, such as FLASH, ROM, etc.) as well as secondary storage in the form of disk storage 412. The set top box typically incorporates other interfaces, such as Ethernet, serial (USB) interfaces, wireless interfaces, etc. This is represented by interface 428 which can accommodate various well known interfaces for data communication. Because the service typically involves inputting text, using a remote control as the sole input means can be slow and using a text entry device such as a PC, PDA, or keyboard is faster. Thus, the set top box may interface with such devices using any well known interface to provide faster text input. Any of these devices can be accommodated by interface 428.

The architecture of the set top box may incorporate many other capabilities to accommodate various types of analog and digital input/outputs, and those skilled in the art will readily be able to identify such. In this embodiment, the chat application is downloaded to the set top box using the carousel, which is an existing method for updating a set top box. The data interface 406 is able to decode the carousel data and provide it to the processor 404, which then loads it into memory 410 or 412 as appropriate. When the user invokes the social networking service using the remote 415, the input is provided to the processor and the processor executes the chat application that is able to communicate with the SNS server or CMS server as appropriate.

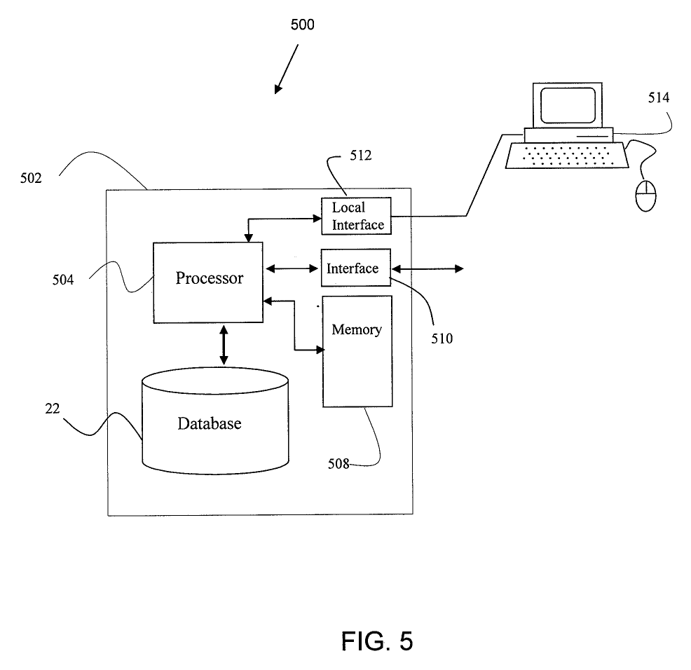

The architecture of the CMS and SNS are similar to each other, and one embodiment of the CMS is shown in FIG. 5. In FIG. 5, the CMS 500 is shown as a processing system 502 that comprises a processor 504 that executes the various CMS programs to accomplish the previously recited functions. The processor accesses a database 506 which stores information about the CGs, members, etc. The memory 508 stores the various programs that are executed. Further, the processor communicates with the headend via an interface 510 (which may be via the SNS) and also communicates via a local interface 512 with the CMS management terminal or computer 514. The SNS has a largely similar architecture, and it may or may not have a separate terminal 514.

### Clipping System

The clipping system operation is disclosed in detail in the aforementioned patent application, the content of which is incorporated by reference. The system operates by copying a live video feed into a VOD-like server which caches the video so that clips can be identified and copied. This does not necessarily require a time delay perceptible to the viewer. Thus, a viewer is not necessarily aware whether a particular program can be “clipped.” If the cable server provider always processes each live video stream through the clipping system, then there is no need to inform the user whether or not the program can be clipped—all programs can be clipped. However, this can be resource intensive for the cable system provider, so only certain programs, or programs at certain times may be processed by the clipping system. Hence it may be necessary to inform the user when a video program can be clipped. A user may also request (via scheduling a Live Event) that a particular program be made eligible for clipping.

Further, the cable service provider may chose to provide the “normal” (e.g., non-clippable) video stream on its regular channel, and provide a copy of the clippable version on another channel. Thus, when a member joins a live event, they may be switched to the alternate channel of the same program.

Consequently, it may be desirable for the CMS system to verify that when a request is made for a CG session for a particular channel (known as a “Live Event”), the video is clippable at that time. The CMS may deny a request for a schedule event based on the type of CG session or if video clips are allowed because of unavailable resources. On the other hand, if the CG group is of the type that prevents video content from being posted, and only allows text messages, then there is no requirement that the common video be processed by the clipping system, and unavailability of the video clipping system is not an issue. Consequently, it is possible to implement a social network service by restricting content to only text messaging, which eliminates the need for incorporating the clipping system in the service architecture.

Based on cable system implementation options, videos which are clippable and scheduled for a CG session, may be copied into the clipping system for that time period. The clippable version of the program may be provided on the regular channel, or may be provided on a different channel (this presumes the non-clippable version is still available on the regular channel). In the latter embodiment, when a user is viewing a program in a non-clippable mode, and requests to join a session, the system may instruct the set top box to tune to the alternate channel, which has the clippable video program. Because there is not necessarily any time delay associated with the clippable version, the user may not even notice they have been switch to an alternate channel. However, the set top box knows that for the new channel, certain stream controls on the remote control may be redefined. Thus, for example, the “record” button (which would record the non-clippable version of the video program) now functions as a “clip” button. However, other embodiments may not necessarily stream both a clippable and non-clippable program, nor redefine the remote control functions.

### Using the Social Networking Service

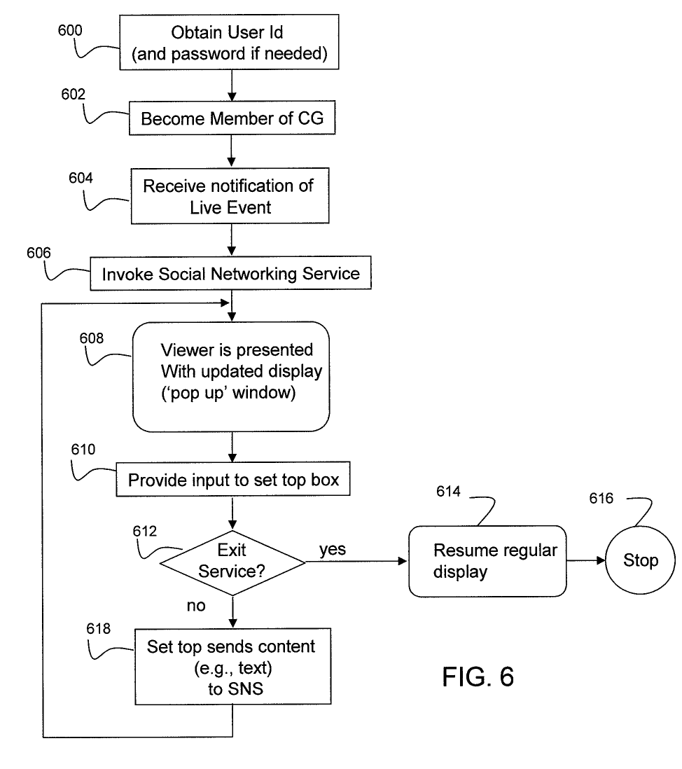

There are various aspects of using the service, which varies based on the type of CG established, its attributes, and other factors. Thus, it is not feasible to discuss each of the possible variations, nor is it necessary to disclose every variation for one skilled in the art to practice the invention. One high level description of a cable system subscriber using the service is shown in FIG. 6. In FIG. 6, the process begins with a viewer (who obviously must be a cable system subscriber), who is presently not a member of any CG. Thus, the first requirement is for the user to obtain a user-id (and password) in step 600. There are various ways that this can occur. One embodiment is for the user to invoke the social network service by pressing a function key on the remote control. The set top box will send in a message invoking the service, preferably with some sort of identifier of the set top box. The CMS is able to use the set top box identifier and determine that no user-id has been assigned. The CMS can then invoke an “assign user-id” procedure.

In another embodiment, the viewer could obtain a user-id via other means. By speaking with a customer service agent, receiving a direct marketing mail piece with a user-id indicated, etc. The user would then enter this into the box when initially invoking the service. A password may be required in some embodiments. For example, a Sponsored CG may be limited to members which have paid a fee or are otherwise a member of an external organization. The sponsor provides the password, and this allows the sponsor to control access to their CG. For the remainder of the illustration, no password is assumed to be required. In other embodiments, the user may interact using the Internet to obtain a user-id and/or password. This could be accomplished by accessing a web site, or by sending an email requesting the information. Regardless of how the information is conveyed to the viewer, the information provided is registered in the CMS system. It is possible to register the user-id prior to the user becoming a member of a CG.

In step 602, the user, now having a user-id, desires to become a member of the CG. In one embodiment, the user may use a texting device communicating with the set top box, to send the appropriate information to the CMS system. In other embodiments, such as in a Private CG, the CG administrator is informed (typically by the user) of the user-id using “out of band” communication channels (such as postal mail, web access, phone calls) and the administrator explicitly includes it as a member of the CG by then entering the information into the CMS. In other types of CG, the user may self register by selecting the CG from a list, and indicating that registration is desired. In this case, the user-id may be communicated by the viewer over the cable distribution plant and stored in the CMS without any administrator involvement. In other embodiments, the user may select the CG and request an invitation, or the CG administrator may send an invitation. Again, this communication could occur using the cable distribution plant or non-cable distribution plan means, such as using SMS messaging, accessing a website operated by the Sponsor to become a member of the CG, sending etc. Regardless of how the user indicates a desire to become a member of a CG group, this information is usually reflected in the CMS by updating the membership list of the CG with the user-id. Thus, there are various ways to become a member, and step 602 actually represents a series of steps that accomplishes that function.

At this point, the viewer has a user-id, is a member of a community group, and participation in a CG session is possible. In some embodiments, the user can perform these steps well in advance of when the CG session becomes active. In other embodiments, the user may perform these steps just before joining a CG session. In this embodiment, the member does not control when the CG session becomes active (the administrator usually determines that). In one embodiment, such as a football game, the member is informed that a CG session will occur concurrently with broadcasting of the game. This information can be brought to the member's attention via advertising separate from the cable system (e.g., alumni newsletters, newspaper advertisements, email notifications, etc.). In addition, it is possible for the social network system to publicize the existence of the CG session to members. The CMS knows when a scheduled Live Event is to occur, and it can send a notification message to the members of the CG. Alternatively, the CMS may send an explicit notification message during the broadcast of the football game to each member indicating the CG session has started. In yet another embodiment, the cable system operator may modify the program image by overlaying an icon image in the corner of the video program that signifies that there is an active CG session that members may join. In another embodiment, the member could access the CMS system and search for upcoming CG sessions for a particular CG or associated with a particular program. In one embodiment, a program-guide like display of active CG session can be presented to the viewer. In summary, the notification to the user of an active CG session at step 604 can occur in various ways.

When the user is aware of an active CG session, the use can then invoke the social network service. This is typically accomplished by pressing a special function key on the remote control when watching a particular program—e.g., football game. Typically, the set top box will then prompt the user to enter a user-id and password. These inputs are received by the set top box and included in a request is sent to the CMS. In some embodiments, the set top box identifier (typically in the form of a MAC address) may also be sent as well (or by itself). If only set top box identified is sent, the CMS system can use the MAC address to then derive the user-id. The CMS uses the user-id to verify the viewer is a member of the CG. The CMS may also validate the user-id by means of the password. Once accepted, the CMS provides the chat room information in response.

As noted, in some embodiments, the set top box identifier can be used to identify the user-id. In such cases, a user-id and/or password may or may not be required. However, using the set top box identifier to determine the user-id links the viewer to using a particular set top box. In other embodiments, the set top box identifier (which may or may not be sent) is not linked the user. Specifically, the set top box may prompt the viewer for a user-id and/or password, and the server in the headend will verify the user is validated based on the password. The server can then ascertain which CGs the user has joined. If there is only one active session, the server knows which CG session the viewer is requesting to joint. If there are multiple active CG sessions which the viewer is a member of, the server could prompt the user as to which CG session they wish to join.

The “chat room information” as discussed before, usually refers to the group of text messages provided by members which is processed by the SNS server and then fed back to the viewers. The headend typically provides information as to how to access the chat room information. The chat room access information may include information about another channel to tune into. Alternatively, if the chat room information is provided via a data carousel, the set top box chat application may know how to obtain it because that information was provided with the chat application when loaded in the set top box. However, the headend may send the set top box chat room access information that identifies one of several chat room information streams conveyed by the carousel. If, however, the chat room information is conveyed using MPEG based data on another channel, then two embodiments are possible. In one embodiment, the chat room information is integrated with the program video and sent as a single MPEG channel. Thus, receiving this channel inherently results in the video image also conveying the chat room messages. In another embodiment, only the chat information is provided on the other MPEG channel. Thus, the set top box is presumed to have two tuners—one tuner that is used to receive the common video program and another tuner that is used to retrieve the chat information. In the first embodiment, the video program and chat information is integrated by the network, while in the second embodiment, the video program and chat information are conveyed as distinct MPEG programs that the set top box integrates in order to generate a signal to the television. In both instances, access information must be provided to the set top box to identify the channel to obtain the chat information. Other variations are possible.

In any case, the set top box chat application adjusts the display provided to the user's television set. Specifically, the set top box either pops a window displaying the chat messages, or reformats the video program into a smaller window, and presents the chat window alongside it. This is represented in step 608 where the viewer is presented with an update display.

The chat window presented includes a limited number of chronological messages, which are scrolled as they are received. Based on various factors, typically embodiments may display the most recent 3-6 postings. The posting comprise text with or without associated video clips (with or without annotations). The provision of a posting with a video clip may be indicated by using an icon. As noted before, the posting does not itself display the real time video, only that a video clip was identified and represents a link that can be selected and viewed.

The member can now watch the common video program (e.g., the football game), in conjunction with the CG session and may be able to control the relative size of the video window and the chat window, typically using the remote control. The member is not required to interact, and may simply view comments posted by others. Indeed, in some embodiments, the user may be prohibited from posting any input.

The user can also opt to exit the service. This is accomplished by the user providing input in step 610 which can interpreted in step 612 explicitly as a request to exit the service. Alternatively, exiting the service may implicitly occur when the user changes channel. However, doing so would effectively preclude a user from channel surfing and participating in an active CG session, as the user would have to re-join the session every time the channel was changed. Other embodiments may allow a user to remain joined in a group while surfing channels. The user may also turn off the set top box or television, which would also implicitly be viewed as a request to exit the service. In any case, exiting the service results in the chat window disappearing, and hence the normal screen image would resume in the regular format in step 614.

Assuming that the member chooses to post input, the member may chose to enter a text message. This is represented by step 610 in FIG. 6. The process of inputting text can occur in various ways. In one way, the set top box is interfaced to a separate text entry device (e.g., PDA, laptop, keyboard), allowing the user to type text. Then, the user indicates completion of text entry (“end of text”) in some manner (e.g., hitting the ‘enter’ key on the keyboard, pressing a function key, etc.). This indicates to the set top box that the information collected should be uploaded to the SNS. This is represented as occurring step 618. In other embodiments, the user may enter a text message using another communications service, such as SMS.

At this point, the information is processed by the SNS application, and the set top box identifier is used by the system to lookup the user-id. The SNS service may receive this and query the CMS, or the message could be sent to the CMS, which informs the SNS of its validity. The text message is posted by the SNS server placing the message (and the user-id) at the top of the queue. If the SNS server generates a MPEG video comprising the chat data, then the MPEG video is updated in real time conveying the new chat information. If the SNS server updates the chat data using a carousel, then the updated chat information is sent out to the community using that method. In either case, the set top box is configured to either display the MPEG video or process the carousel data in real time as appropriate. Thus, the member views their own posting as appearing on the chat window on their television screen. Obviously, other members of the CG participating in the active CG session receive and view the information as well.

The user may also be allowed to post a video clip. When doing so, the click-to-click service or video clipping service is invoked. In one embodiment, the set top box collects information regarding the clip comprising a channel identifier, a start time, and an ending time. This information, along with the set top box identifier, is sent to the SNS server. If text is provided, it can be entered by the user and transmitted along with the aforementioned information or subsequently. The SNS server then posts the content to the chat board. In this context, the “chat board” or “chat room” represents the information received by the SNS service that is processed and redistributed to the members. Thus, the information viewed can be thought of as the “chat board.” The SNS server does not actually post the member's communication comprising the channel identifier, start time, etc. Posting this information would not be conducive to comprehension by the members. Rather, in one embodiment, the SNS server determines a link or other shorthand address and posts an icon representing a video clip and the user-id to the chat board, along with any text, if present. After posting, the members see that a message has been posted from the source identified by the user-id and that there is an associated video clip identified.

Members when viewing the chat board can scroll and select a message posting that has a video clip icon, and select it to view the video clip. When the user does this, the SNS server receives the request, and ascertains that this is a request to view a video clip. Such inputs from the user are not posted by the SNS server. Specifically, this request is not reflected in the chat information. Thus, other members are not aware of other members viewing select video clips.

The SNS server interacts with the video clipping system to retrieve the identified clip, and it is provided to that user. There are various ways that this can occur. In one embodiment, a spare channel is selected and is used by the clipping system to begin streaming the video selected by the member. The clipping system and the SNS are both aware of the channel being used (this function may involve the CMS system). The SNS (or the CMS) then informs the set top box of the channel the clipping is being streamed. The set top box then tunes to that channel, and processes that video into the chat window (or into the common program window). After the video completes, the set top box replaced the image in the chat window with the current status of the chart board. In this manner, the members can post a video clip. The other members can select a particular posting associated with a video clip, and view the video clip in their chat window.

### Specific Embodiments of the Service

The flexibility in defining various groups and interactions, as well as the different levels of social interaction contributes to the flexibility of the service for various applications. Several high level applications of the service are described, and it is apparent how the aforementioned attributes and features can be used to accomplish the applications.

In one application, a View Only CG is created. This can be analogized in purpose to an Internet “blog”, where a person wishes to inform others of their views and opinions. The View Only CG could be a for-profit site, where a well known expert provides commentary during broadcasts of sports games. The expert desires to inform others why a certain team is performing so well. The CG can be public in membership, where advertising is provided in order to generate revenues for the CG administrator. Alternatively, a community activist could create a CG where their comments are posted when viewing a televised meeting of the local board of education on a public service channel. This CG administrator may maintain a clipping library of prior meetings, and provide comments (along with specific video clippings) to inform CG members of prior meetings.

Another application involves a presentation or public service meeting is being broadcast live (e.g., county commission, board of education meeting, etc.) The CG administrator may allow members (which may be a limited group) to post text messages comprising questions, which are displayed in real time. The speaker can view the messages in real time on a television, and address the content of the questions as he speaks. This provides a limited interactive forum, which allows remote questions to be viewed by everyone and addressed by the speaker.

In another application, a Sponsored CG can be created for fans of a sports team. Membership can be controlled by requiring a password, which can be assigned by an organization (fan club, alumni organization). Members may be targeted for advertising based on the CG they are members of, and/or while an CG session is active. Further, the administrator may variously limit the input capability provided by some members in order to maintain an orderly interactive session.

### Illustrative Images

FIG. 7 provides various illustrative images of the service in operation. There are various screen images that are presented to a member at various times. It is not feasible to provide all the images that a user may encounter, such as obtaining a user-id, creating a CG, scheduling a CG session, etc.

The image in FIG. 7a represent a normal image 700a comprising the common video that a member is viewing. Although the word “image” is used, it is obvious that it refers to a dynamic video presentation. The member may be cognizant that an active CG session is occurring, either by prior notification (e.g., an alumni newsletter, by searching for active CG sessions associated with the CG, accessing an on-line schedule, or receiving a notification message). The user then invokes the service by selecting the function key on the remote, and a pop up chat window appears.

In one embodiment shown in FIG. 7b, the chat window 702 is overlaid on top of the image 700b. However, as evident, important information in the video may be hidden. The member may be able to relocate the position and size of the chat window. Another embodiment is shown in FIG. 7c. In this embodiment, the common video window 700c is reduced and a separate chat window 704 is opened on the screen. In this embodiment, although the image 700c is smaller, it is still viewable in its entirety. A variation of the embodiment shown in FIG. 7b is to overlay the chat window where the chat window has a transparent background. In this variation, only the text in the chat window appears to be overlaid, and this minimizes the impact to the user of the chat window hiding the common video.

After invoking the service, the set top box either tunes to a channel or processes the carousel data to present the chat information in the chat window. An exemplary sequence of chat messages is shown in FIG. 7d In FIG. 7d the chat window 706 comprises a number of prior contents posts from users. Specifically, four posts are shown in the window. The number may be limited by space to a certain number of posts or a maximum number of characters. In this example, the text of the post is shown followed by the user-id. For example, the most recent post (shown at the top) is from a user known as “BigFan” 708. The second post includes a video clip, as indicated by an icon 710. Users can use their remote controls to scroll through the list, and select a particular posting for purposes of viewing the video.

If the user selected the video indicated by the icon 710, the system would retrieve the video and replace the image 700d with the video clip. Once completed, the common video would be restored.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

That which is claimed:

1. A system for providing a social network service to a viewer of a video program in a cable distribution system, wherein said viewer uses a set top box to originate a request to join an active community group (“CG”) session, said set top box originating a text message provided by said viewer, said system comprising:
a server configured to receive a user-id originating from said set top box provided to said set top box by said viewer, said server configured to determine said user-id is associated with a membership list of a community group associated with said community group session, said server further configured to receive from said cable distribution network a text message originating from said set top box, said server further configured to process said text message and produce chat information comprising 1) said text message and said user-id, and 2) another text message and another user-id, said server configured to transmit said chat information over said cable distribution network wherein said set top box and at least one other set top box are configured to receive said chat information; and
a database storing said membership list comprising said user-id wherein database further stores an association of said membership list and said community group.

2. The system of claim 1 wherein the server is further configured to provide said chat information to said set top box and said at least one other set top box by transmitting said chat information on a broadcast carousel over said cable distribution network.

3. The system of claim 1 wherein the server is further configured to provide said chat information to said set top box and said at least one other set top box by causing said chat information to be incorporated into an MPEG based video stream transmitted over said cable distribution network.

4. The system of claim 1 wherein said server is configured to receive from said set top box video clip identification data comprising a channel identifier, a starting time, and an ending time.

5. The system of claim 1 wherein said server is configured to determine said user-id is authorized to provide input prior to producing said chat information, wherein authorization is determined in part by retrieving a content input restriction parameter stored in said database associated with said community group.

6. The system of claim 1 wherein said database stores a plurality of attributes associated with said active community group session, said attributes comprising: 1) an identifier of the community group, 2) an administrator of the community group, and 3) a content input restriction associated with one or more members of the community group.

7. The system of claim 1 wherein said server is configured to determine said user-id for inclusion in said chat information by receiving a set top box identifier from said set top box and using said set top box identifier to determine the user-id.

8. The system of claim 3 wherein said chat information is integrated with said video program in a MPEG video stream prior to transmitting said chat information.

9. A method of providing a social network service to a subscriber of a cable system comprising the steps of:
receiving a MPEG digital video signal at said set top box from a cable distribution network, said set top box processing said MPEG digital signal to generate an output signal to a television set displaying a video program conveyed by said MPEG digital signal;
receiving input at the set top box from said subscriber comprising a request to join an active community group session wherein said input is received from a wireless interface at said set top box communicating with a remote control;
modifying said output signal by said set top box to convey a prompt to said subscriber for entering a user-id;
receiving said user id from said subscriber at said set top box;
generating a request by said set top box over said cable distribution network comprising said user-id;
receiving chat information at the set top box wherein said set top box provides said chat information to said television using said output signal;
receiving a text at said set top box originating from said subscriber while said output signal provides said video program to said television, said input comprising a text message followed by an end-of-text indicator;
transmitting said text message from said set top box to a cable interface of the set top box connected to the cable distribution network;
receiving chat information at the set top box from the cable distribution network, wherein said chat information comprises said text message originating from said set top box and further comprises a second text message originating from another set top box; and
providing said output signal conveying said video program and said chat information wherein chat information comprises both said text message originating from said set top box and said second text message originating from another set top box.

10. The method of claim 9 wherein the step of receiving chat information over the cable distribution network comprises receiving a second MPEG digital signal, and the step of providing said output signal to convey said video program and said chat window comprises using a second MPEG digital signal to modify said output signal.

11. The method of claim 9 wherein said output signal comprising a first window comprising said video program and a second window comprising said second MPEG digital signal.

12. The method of claim 9 wherein the step of transmitting said text input from said set top box to the cable distribution network further comprises transmitting said user-id with said text input.

13. A method of providing a social network service to a subscriber of a cable system comprising the steps of:
storing an indication in a database located in a cable system, said indication comprising a name associated with a community group;
storing in the database in association with the community group a user-id of an administrator of the community group;
storing a plurality of user-ids in a membership list in the database in association with the name of the community group;
storing a video program identifier in association with the community group in said database, said video program identifier identifying a video program transmitted over said cable system;
activating a community group session of the community group for processing input at a defined time in a server, wherein the defined time coincides with the beginning of said video program being transmitted over cable system;
receiving a first input at the server originating from a first set top box over the cable system after said activation of said community group session wherein said first input comprises a user-id;
receiving a second input at the server originating from said first set top box after said first input, said second input comprising a first text message;
determining said user-id is indicated in said membership list stored in said database for said community group;
formulating in the cable headend a signal comprising data of said first text message from said first set top box; and
transmitting said signal by said cable headend over a cable distribution network comprising said first text message from said first set top box.

14. The method of claim 13 wherein the signal transmitted over said cable distribution network comprises said user-id.

15. The method of claim 14 wherein the signal transmitted further comprises a second text message and a second user-id, wherein said second text message originated from a second set top box.

16. The method of claim 13 wherein the first text message at the server originating from the first set top further comprises identification data identifying a video clip, said identification data comprising a program identifier, a beginning point of the video clip, and an ending point of the video clip.

17. The method of claim 16 wherein said signal transmitted by said cable headend comprising data of said first text message further comprises said video clip.

18. A social networking system for providing a social networking service in a cable distribution system, said system comprising:
a database configured to store data associated with a community group, said data comprising a community group identifier, a community group administrator, a membership list, and data input restrictions associated with members indicated in said membership list; and
a server configured to create an active community group session associated with a video program being transmitted over a cable distribution network,
said server configured to receive a request from a set top box to join said active community group session,
said server configured to verify a user-id associated with said request by determining said user-id is authorized to join said active community group session by using said membership list,
said server configured to receive an input comprising a text message originating from said set top box receiving said video program,
said server configured to generate a signal comprising said input wherein said signal conveys at least one other input comprising another text message from another member of said active community group session, and
said server configured to provide said signal over said cable distribution network to a plurality of set top boxes including said set top box.

19. The system of claim 18 wherein the signal comprising said input and said one other input is transmitted over said cable distribution network using a data carousel.

20. The system of claim 18 wherein said input from said set top box further comprises a video clip identifier.

21. A computer readable media comprising steps executable by a processor in a set top box operating with a cable distribution system, said steps comprising:
receiving an input at said processor in said set top box, said input said input requesting a social network service wherein said social network service is associated with a digital video program presently received at an input interface of said set top box;
generating a digital video output signal for a television, said digital video signal output providing a prompt for user to enter a user id;
transmitting a request over the cable distribution system comprising said request for said social network service and a said user-id;
receiving chat information transmitted on the cable distribution system associated with an active community group session,
providing said digital video output signal to said television, wherein said video output signal conveys said video program and said message chat information, wherein said video program is presented in a first window on said television and said message chat information is presented in a second window on said television;
receiving text input from said user at said set top box;
transmitting said text input over said cable distribution system to a server in a cable headend; and
receiving subsequent chat information from the cable distribution system comprising said text input from said set top box and additional text input from another set top box.
